(19) United States
(12) Patent Application Publication
(10) Pub. No.: US 2011/0063191 A1
(43) Pub. Date: Mar. 17, 2011

(54) METHOD OF MANAGING APPLICATIONS IN A MULTI-MONITOR COMPUTER SYSTEM AND MULTI-MONITOR COMPUTER SYSTEM EMPLOYING THE METHOD

(75) Inventors: Andrew Leung, Calgary (CA); Viktor Antonyuk, Calgary (CA)

(73) Assignee: SMART TECHNOLOGIES ULC, Calgary (CA)

(21) Appl. No.: 12/811,689

(22) PCT Filed: Jan. 7, 2009
(86) PCT No.: PCT/CA2009/000016

§ 371 Date: Oct. 26, 2010

Related U.S. Application Data
(60) Provisional application No. 61/019,480, filed on Jan. 7, 2008.

(51) Int. Cl. G09G 5/00

(52) U.S. Cl. 345/1.1

(57) ABSTRACT

A method of managing applications in a multi-monitor computer system (20) comprising a plurality of displays (22 to 26 and 30 to 34), comprises displaying representations of available applications in the multi-monitor computer system on one of the displays and in response to selection of a representation of an application that is available on a different display, transferring the application associated with the selected representation to the display from which the selection was made.

### FIELD OF THE INVENTION

The present invention relates generally to multi-monitor computer systems and in particular, to a method of managing applications in a multi-monitor computer system and to a multi-monitor computer system employing the method.

### BACKGROUND OF THE INVENTION

Multi-monitor computer systems comprising multiple physical display devices connected to a common computing device such as for example a personal computer or the like, in order to provide an increased display area for computer programs running on the computing device, are becoming increasingly more popular. Depending on the environment, the physical display devices may be of different types (eg. liquid crystal displays (LCDs), cathode ray tubes (CRTs), interactive whiteboards (IWBs), other display panels or devices etc.) and/or different sizes. In order to accommodate multiple physical display devices, video cards in many computing devices have multiple sockets to receive cables from more than one physical display device. Alternatively, some computing devices have multiple video cards to receive cables from more than one physical display device. In either case, video data generated by the video card(s) of the computing device in response to execution of one or more computer programs is output to the appropriate physical display device for display. Other multi-monitor computer systems have networked physical display devices where the physical display devices are connected via a wireless or wired network and video data is provided to the physical display devices via the network connection for display.

As is well known in Windows™-type operating system environments, when an application is to be launched as a result of being selected through a double-click mouse or similar event, the operating system creates an instance of the selected application and launches the selected application within a window presented on the physical display device. The window for the selected application is typically placed in one of two positions; either at its location of last use or at a default location. When it is desired to move an application window from one physical display device to another, the user must manipulate the displayed application window so that the application window is moved to the desired physical display device. When the physical display devices are closely spaced, although having to manipulate the displayed application windows may be inconvenient, it is a task that can be readily performed by the user. In multi-monitor computer systems employing interactive whiteboards, the interactive whiteboards may be separated by appreciable distances. In this case, if a user interacting with one interactive whiteboard wishes to interact with an application window displayed on another interactive whiteboard, the user must walk to the interactive whiteboard displaying the application window of interest, manipulate the application window as required so that the application window is transferred to the appropriate interactive whiteboard and then walk back. This of course can be inconvenient, lead to user frustration and to a reduction in the utilization of software features. As will be appreciated improvements in the management of applications running on multi-monitor computer systems are desired.

It is therefore an object of the present invention at least to provide a novel method of managing applications in a multi-monitor computer system and to a multi-monitor computer system employing the method.

### SUMMARY OF THE INVENTION

Accordingly, in one aspect there is provided a system comprising a plurality of displays operatively associated with at least one computing device executing an application management procedure, the application management procedure determining instances of applications available on the displays and enabling an application selected from one display that is available on another display to be moved from that other display.

In one embodiment, the application management procedure causes a representation of each application available on the displays to be presented on a selected display. The application management procedure is invoked in response to user selection of a displayed icon and the selected display is the display from which the displayed icon is selected. The representation of each application is a selectable thumbnail.

In one embodiment, the plurality of displays comprises a plurality of interactive whiteboards. The application selected from the one display is moved from the other display to the one display and may be presented on the one display in a format and location similar to that as previously presented on the other display. If desired, the application management procedure can animate the selected application during movement of the selected application from the other display to the one display and/or broadcast a sound effect during movement of the selected application from the other display to the one display.

According to another aspect there is provided a method of managing applications in a multi-monitor computer system comprising a plurality of displays, said method comprising displaying representations of available applications in the multi-monitor computer system on at least one of the displays; and in response to selection of a representation of an application that is available on a different display, transferring the application associated with the selected representation to the display from which the selection was made.

In one embodiment, the displaying comprises presenting an array of symbols representing the available applications. The displaying is performed in response to selection of an icon presented on the one display. The user input in one form is touch input made on the one display. The transferring in one form comprises displaying the application associated with the selected representation on the display from which the selection was made. The application may be displayed in a format and location similar to that as presented on the different display.

According to yet another aspect there is provided a multi-monitor computer system comprising a plurality of displays operatively associated with a central computing device executing an application management procedure, said application management procedure, in response to user input made on one of said displays, at least determining applications running on said central computing device that are available for presentation on the displays, and displaying selectable representations of the applications on the one display, said application management procedure in response to selection of a displayed representation associated with an application available on a display different from said one display, moving the availability of the application corresponding to the selected representation from the different display to the one display.

According to yet another aspect there is provided a computer readable medium embodying a computer program for managing applications in a multi-monitor computer system comprising a plurality of displays, said computer program comprising program code for displaying representations of available applications in the multi-monitor computer system on at least one of the displays; and program code for, in response to selection of a representation of an application available on a different display, transferring the application associated with the selected representation to the display from which the selection was made.

According to yet another aspect there is provided a method of managing applications in a multi-monitor computer system comprising a plurality of displays, the method comprising displaying at least one application move icon associated with an application window presented on one of said displays; and in response to selection of the at least one application move icon, transferring display of the application window from the one display to another display.

According to still yet another aspect there is provided a computer readable medium embodying a computer program for managing applications in a multi-monitor computer system comprising a plurality of displays, said computer program comprising program code for displaying at least one application move icon associated with an application window presented on one of said displays; and program code for, in response to selection of the at least one application move icon, transferring display of the application window from the one display to another display.

### BRIEF DESCRIPTION OF THE DRAWINGS

Embodiments will now be described more fully with reference to the accompanying drawings in which:

FIG. 1 is a schematic representation of a multi-monitor computer system;

FIG. 2 shows a multi-monitor computer system deployed in a meeting room and comprising a plurality of interactive whiteboards, a central computer and a plurality of laptop computers;

FIG. 3 shows the interactive whiteboards and two laptop computers of FIG. 2, the desktops of the laptop computers being displayed on two of the interactive whiteboards;

FIGS. 4A to 4C are flowcharts illustrating the steps performed during execution of an application management procedure executed by the central computer;

FIGS. 5A to 5E show movement of a displayed application window during execution of the application management procedure;

FIG. 5F shows a desktop presented on an interactive whiteboard including a bubble window; and

FIGS. 6A to 6D show movement of a displayed application window in response to an application window move (AWM) icon selection during execution of the application management procedure.

### DETAILED DESCRIPTION OF THE EMBODIMENTS

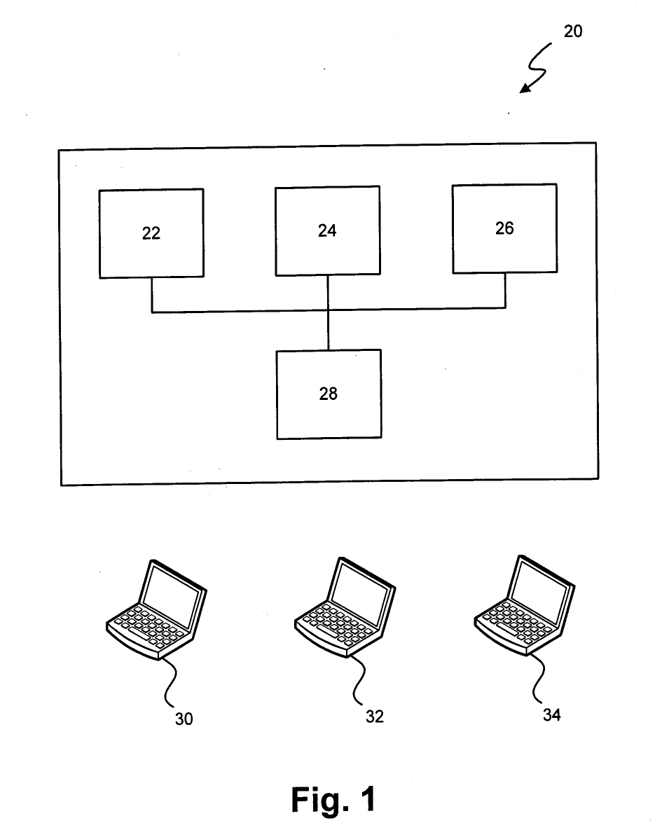

Turning now to FIG. 1, a multi-monitor computer system is shown and is generally identified by reference numeral 20. As can be seen, in this embodiment the multi-monitor computer system comprises a plurality of physical display devices 22 to 26, each of which is connected to a common computing device, in this case a central computer 28. The physical display devices 22 to 26 may take a variety of forms. For example, the physical display devices may be monitors (eg. liquid crystal displays (LCDs), cathode ray tubes (CRTs), plasma display devices or other type of display panel) of the same type or of different types and/or may be of the same or different resolution. Alternatively, the physical display devices 22 to 26 may be interactive whiteboards (IWBs). Each IWB may be one of a number of types including but not limited to analog resistive, capacitive, camera-based, electromagnetic, surface acoustic wave etc. Of course, the physical display devices 22 to 26 may be a combination of monitors and IWBs. One or more other local and/or remote computing devices also communicate with the central computer 28. In this embodiment, three (3) local laptop computers 30 to 34 are shown communicating with the central computer 28. The laptop computers 30 to 34 may communicate with the central computer 28 via windows sharing software over wired communication links such as for example Ethernet or universal serial bus (USB) connections, or may communicate with the central computer 28 over wireless communication links such as for example radio frequency (RF) or BlueTooth™ connections. Although not shown, one or more remote other computing devices such as for example laptop computers, desktop computers or the like may communicate with the central computer 28 via windows sharing software over an Internet, virtual private network (VPN) or similar communication link. The windows sharing software may be one of a variety of types such as that offered by SMART Technologies ULC of Calgary, Alberta, Canada, assignee of the subject application, under the name SynchronEyes™, Bridgit™ or LinQ™ or that offered by third parties under the name WebEx™, Microsoft Remote Desktop, Netmeeting, Windows Live™ or VNC™.

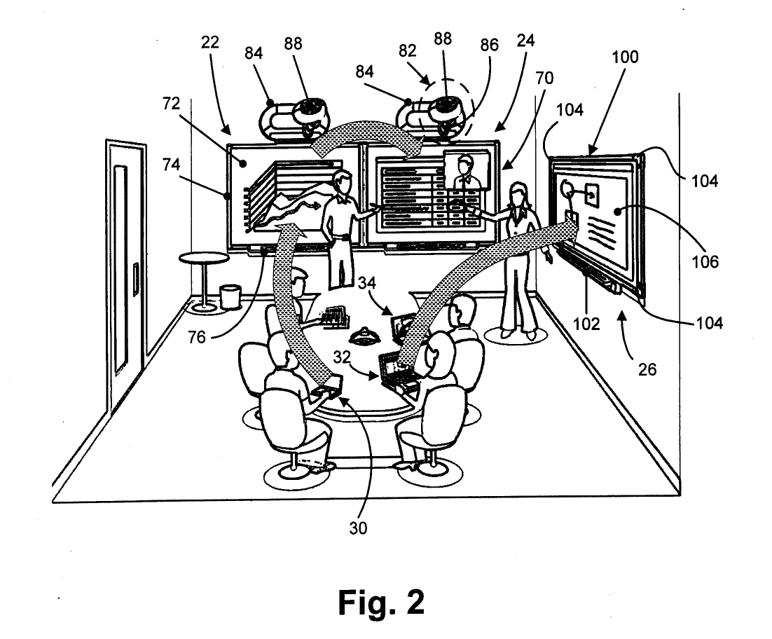

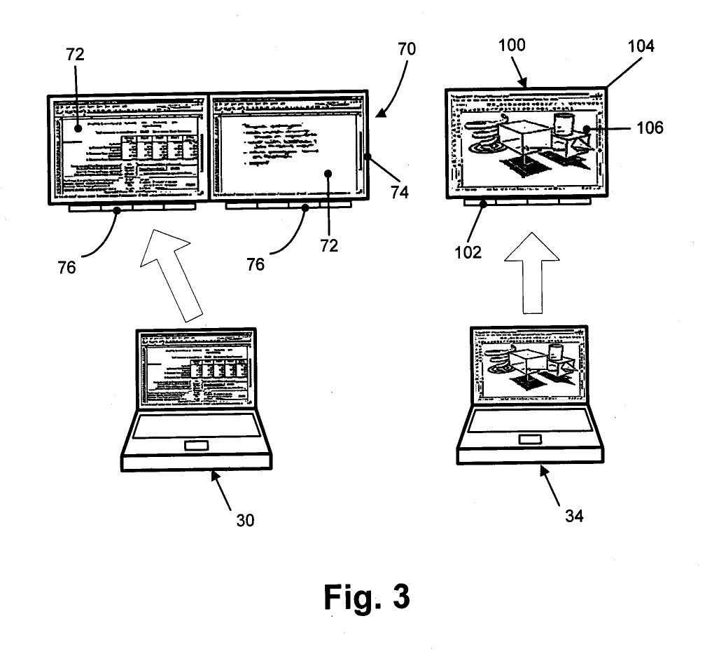

FIGS. 2 and 3 show the multi-monitor computer system 20 deployed in a meeting room and with the physical display devices 22 to 26 taking the form of interactive whiteboards (IWBs) mounted on the walls of the meeting room at physically spaced locations. Each IWB 22 to 26 is connected to the central computer 28 either via a cable that is received by a respective socket of a video card installed in the central computer 28 or via a network connection. The laptop computers 30 to 34 in this configuration communicate with the central computer 28 via wireless communication links. Alternatively, each IWB 22 to 26 may comprise an embedded processing unit that controls its display and that receives communication directly from one or more of the laptop computers 30 to 34.

In this embodiment, IWBs 22 and 24 are 600i series interactive whiteboards manufactured by SMART Technologies ULC, of Calgary, Alberta, Canada, assignee of the subject application. As can be seen, each IWB 22, 24 comprises an analog resistive touch screen 70 having a touch surface 72. The touch surface 72 is surrounded by a bezel 74. A tool tray 76 is affixed to the bezel 74 adjacent the bottom edge of the touch surface 72 and accommodates one or more tools that are used to interact with the touch surface 72.

A boom assembly 82 is mounted above the touch screen 70 via a mounting bracket 84. The boom assembly 82 comprises a generally horizontal boom 86 that extends outwardly from the mounting bracket 84 and supports a projector 88 adjacent its distal end. The projector 88 is aimed at the touch screen 70 so that the image projected by the projector 88 is presented on the touch surface 72.

During operation of each IWB 22, 24, the projector 88 receives video output from the central computer 28 and projects a video image onto the touch surface 72. The video image may be the desktop of the central computer 28 or the desktop of one of the laptop computers 30 to 34. When a user contacts the touch surface 72 of one of the IWBs with a pointer such as a finger, pen tool, or other object, the contact is detected by the IWB and the position of the contact in touch screen (x,y) coordinates is conveyed to the central computer 28. The central computer 28 in response maps the touch screen (x,y) coordinates to the computer display coordinates and processes the resultant input. Depending on the nature of the resultant input, the touch surface contact may be treated as writing or drawing or as a mouse event. As a result, pointer contacts on and pointer movements across the touch surface 72 can be recorded by the central computer 28 as writing or drawing or used to control execution of one or more application programs loaded on the central computer 28. The central computer 28 also updates the video output conveyed to the projector 88 so that the video image presented on the touch surface 72 reflects the pointer activity.

IWB 26 is a DViT camera-based interactive whiteboard manufactured by SMART Technologies ULC, of Calgary, Alberta, Canada, assignee of the subject application and is similar to those described in U.S. Pat. Nos. 6,803,906; 6,972,401; and 7,236,162. The IWB 26 comprises a rectangular bezel or frame 100 surrounding the display screen of a projection device such as for example a plasma display or LCD. A tool tray 102 is affixed to the bezel 100 and accommodates one or more pen tools that are used to interact with the projection device. The projection device receives video output from the central computer 28 and displays a video image on its display screen 106. Digital cameras 104 are provided adjacent at least two corners of the bezel 100. The digital cameras 104 have overlapping fields of view that encompass and look generally across the display screen 106.

During operation, the digital cameras 104 acquire images generally looking across the display screen 106 from different viewpoints and generate image data. Image data acquired by the digital cameras 104 is processed by on-board digital signal processors to determine if a pointer exists in the captured image data. When it is determined that a pointer exists in the captured image data, the digital signal processors generate pointer information packets (PIPs) and convey the PIPs to a master controller. Upon receipt of the PIPs, the master controller processes the PIPs using triangulation to determine the location of the pointer in the captured images relative to the display screen (x,y) coordinates. In this manner, as PIPs are generated in response to captured images, the position and movement of the pointer over the display screen 106 can be tracked turning the display screen 106 of the projection device into an interactive touch surface. The display screen (x,y) coordinates generated by the master controller are conveyed to the central computer 28. Similarly, the central computer 28 in response maps the display screen (x,y) coordinates to computer display coordinates and processes the resultant input. Depending on the nature of the resultant input, the display screen contact may be treated as writing or drawing or as a mouse event. As a result, pointer contacts on and pointer movements across the display screen 106 can be recorded by the central computer 28 as writing or drawing or used to control execution of one or more application programs loaded on the central computer 28. The central computer 28 also updates the video output conveyed to the projection device so that the video image presented on its display screen 106 reflects the pointer activity.

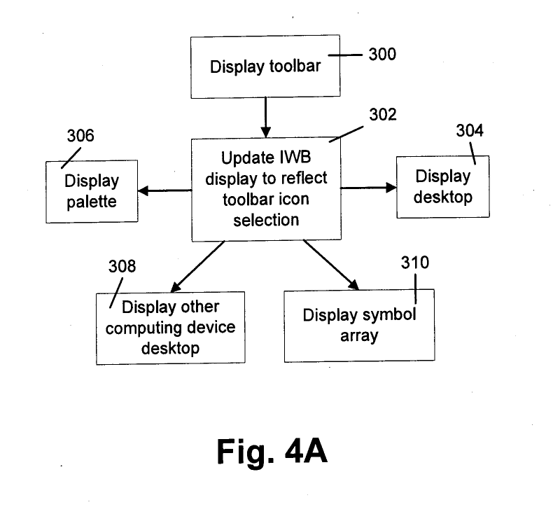

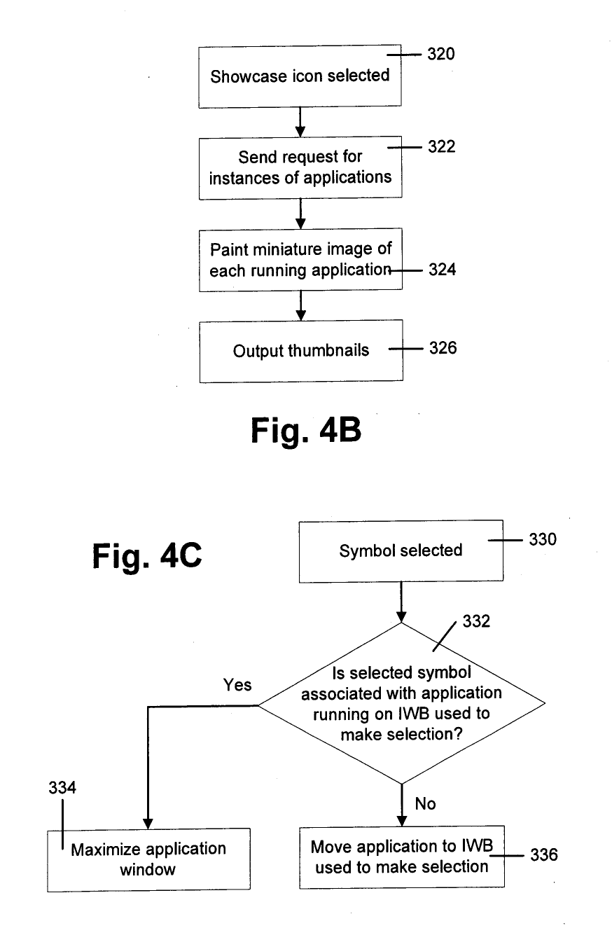

As mentioned previously, in multi-monitor computer systems employing IWBs, difficulties can arise when a user wishes to interact with an application that is running on a remote IWB. To obviate these difficulties, the central computer 28 executes an application management procedure that enables a user to change the location at which running applications are displayed as will now be described with particular reference to FIGS. 4A to 4C.

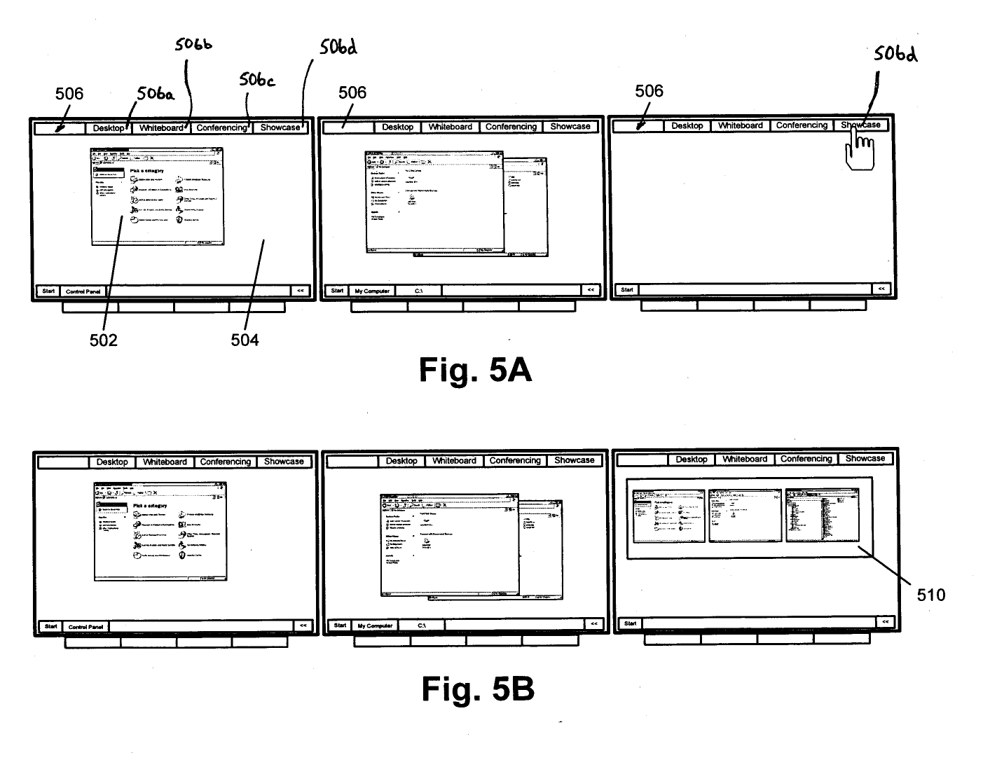

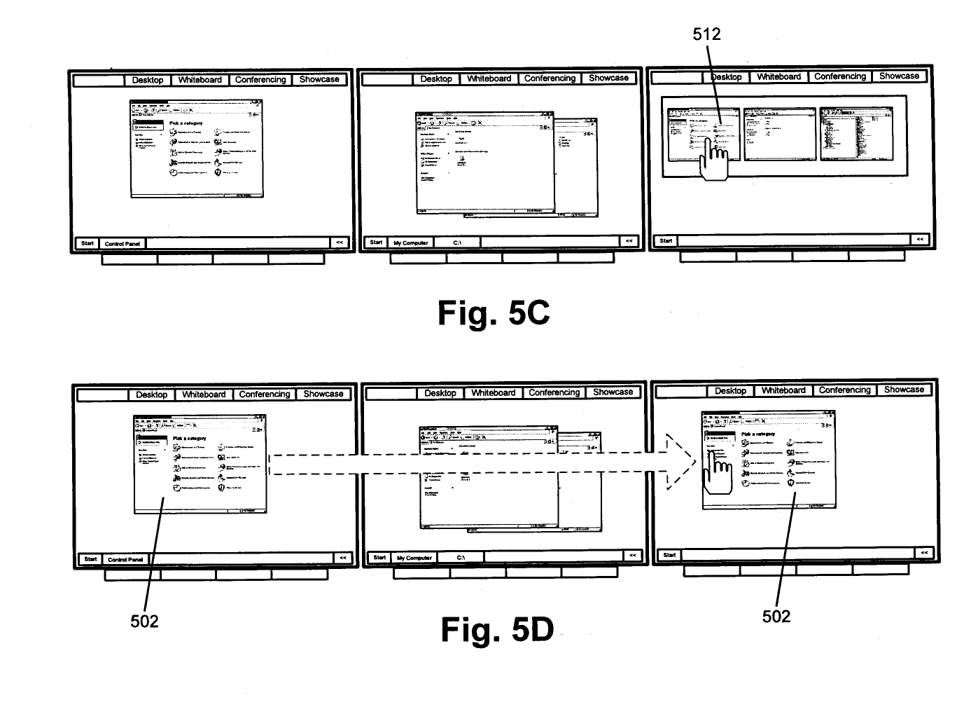

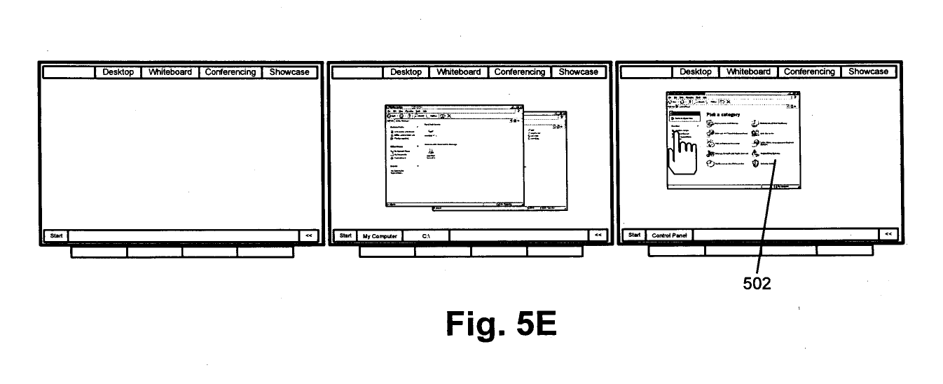

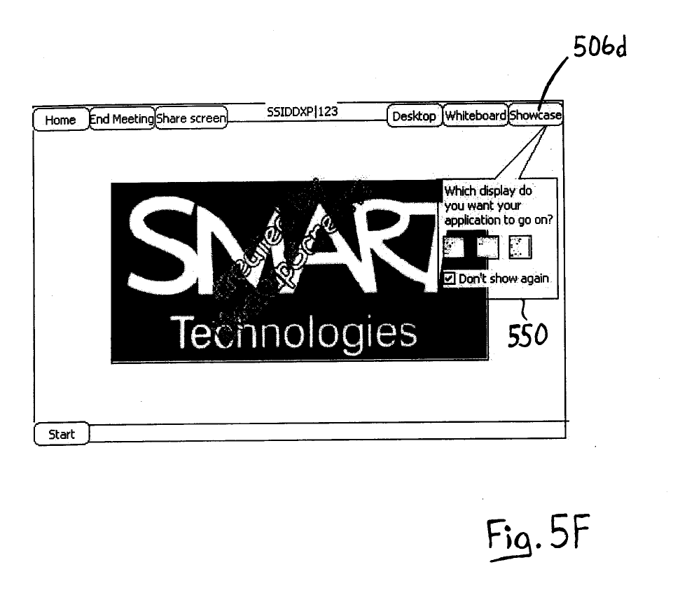

During execution of the application management procedure, a toolbar 506 (see FIG. 5A) is displayed on each of the IWBs 22 to 26 adjacent the top of the touch surface 72, 106 (step 300). Those of skill in the art will appreciate that the toolbar may of course be displayed on each of the IWBs or only on selected IWBs at any desired position. The toolbar in this embodiment comprises a desktop icon 506a, a whiteboard icon 506b, a conferencing icon 506c and a showcase icon 506d. When a user interacts with the touch surface 72, 106 of one of the IWBs and selects one of the icons of the toolbar 506, the display presented on the touch surface of that IWB is updated to reflect the pointer activity (step 302). In particular, if the desktop icon 506a is selected, the central computer 28, in response to the touch input, provides video output to the IWB so that the desktop of the central computer 28 is displayed on the touch surface (step 304). If the whiteboard icon 506b is selected, the central computer 28, in response to the touch input, provides video output to the IWB so that a drawing palette is displayed on the touch surface (step 306). If the conferencing icon 506c is selected, the desktop of one of the local or remote other computing devices (in this example, laptop computers 30 to 34) communicating with the central computer 28 can be selected for display on the touch surface (step 308). If the showcase icon 506d is selected, the central computer 28, in response to the touch input, provides video output to the IWB so that an array of symbols, representing instances of the various applications that are running on the central computer 28 and/or on the local and/or remote other computing devices communicating with the central computer 28, is displayed on the touch surface (step 310). In this embodiment, the symbols are thumbnails (i.e. small image replicas) of the running applications.

At step 302, when the user selects the showcase icon 506d (step 320), the application management procedure, in response to touch input, sends a request to the Windows operating system for a list of all instances of the applications that are currently running on the central computer 28 (step 322). If desired, the application management procedure can send a similar request to the local and/or remote other computing devices via an integration module supported by the windows sharing software. For each application instance identified in response to the request(s), the application management procedure paints a miniature image of each application using a basic graphic scaling algorithm or optionally a direct hardware capture or hardware scaling (step 324) thereby to create the array of thumbnails. The array of thumbnails is then output for display on the touch surface of the IWB (step 326)

When the user selects one of the symbols from the array (step 330), the central computer 28, in response to the touch input, performs a check to determine where the instance of the application associated with the selected symbol is currently running (step 332). If the selected symbol represents an application that is currently running on the IWB used to select the symbol, the window in which the running application is displayed is maximized on the IWB (step 334). If the selected symbol represents an application that is running on an IWB that is different from the IWB used to select the symbol, the central computer 28 moves the application window to the IWB on which the symbol selection was made and displays the application window in same manner and in the same position as displayed on the previous IWB (step 336). As a result, if the application window associated with the selected symbol was in a minimized state, the application window when moved to the target IWB remains in the minimized state. If the application window associated with the selected symbol was in a maximized state, the application window when moved to the target IWB remains in the maximized state. Of course, the application window when moved to the target IWB can be displayed in any desired state and need not conform to its previous state. For example, regardless of the state of the application associated with the selected symbol, the application window when moved to the target IWB can be defaulted either to a minimized state, a maximized state or even full screen. Also, the application window can be defaulted to any desired position on the touch surface of the target IWB. If desired, movement of the application window from one IWB to another IWB can be fully animated across the IWBs, and any intervening IWBs, if they exist, or moved without animation. Also, if desired sound effects can be broadcast to accompany the movement of the application window from one IWB to another IWB.

FIGS. 5A to 5E show the sequence of events during movement of an application window by the application management procedure in response to touch input. As can be seen in FIG. 5A, the touch surface of the leftmost IWB displays an application window 502. In the same figure, the showcase icon 506d of the toolbar 506 displayed on the touch surface of the rightmost IWB is being selected via touch input. In response to selection of the showcase icon 506d as shown in FIG. 5B, the touch surface of the rightmost IWB displays the array of symbols representing the applications running on the central computer 28. As shown in FIG. 5C, the symbol 512 corresponding to the application window displayed on the leftmost IWB is being selected via touch input. As shown in FIG. 5D, in response to the symbol selection, the application window 502 is moved from the leftmost IWB to the rightmost IWB in an animated fashion. In FIG. 5E, with the application window move complete, the application window 502 now displayed on the rightmost IWB is in the same form and position as on the leftmost IWB.

During movement of the application window from one IWB to another, if the display area coordinates of the two IWBs are different, the central computer 28 adjusts the coordinates of the application window to conform to the display area coordinates of the target IWB.

In an alternative embodiment as shown in FIG. 5F during execution of the application management procedure, when a symbol from the array is selected and the user re-selects the showcase icon 506d, a bubble window 550 is presented that shows a representation of the available IWBs and includes a prompt asking the user to select the IWB to which the application window associated with the selected symbol is to be moved. When an IWB representation in the bubble window 550 is selected, the central computer 28 moves the application window associated with the selected IWB representation to that IWB.

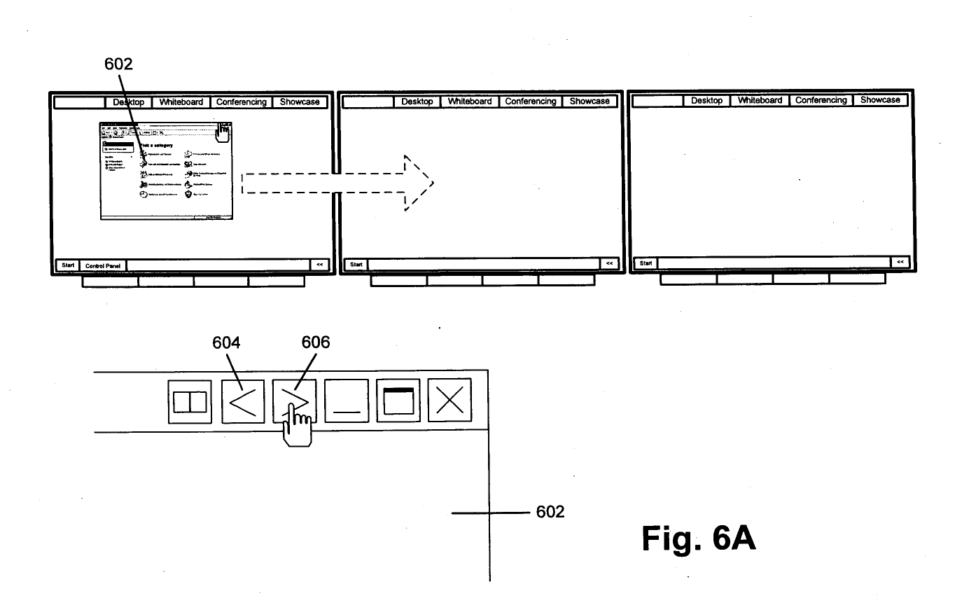

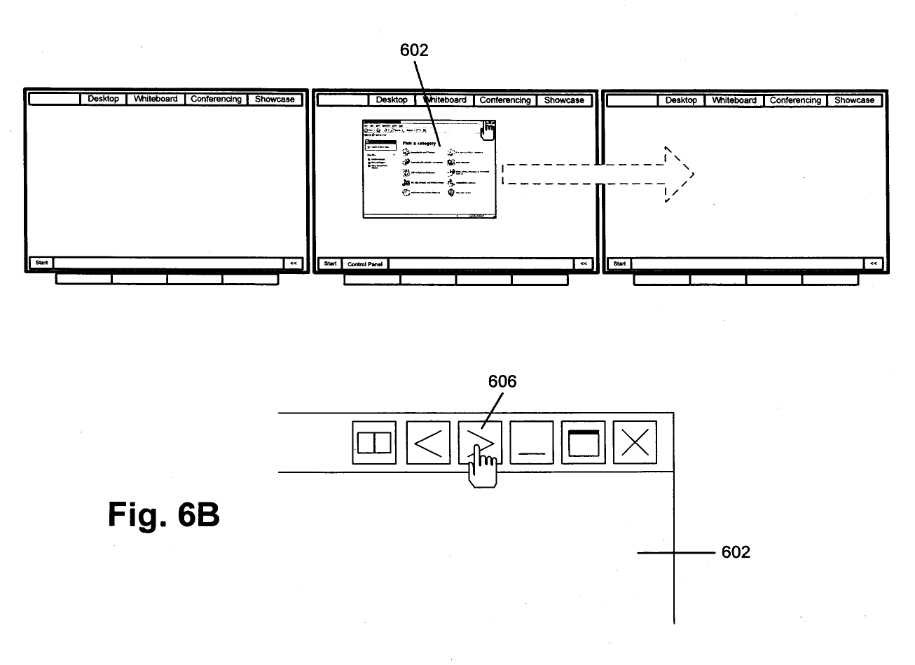

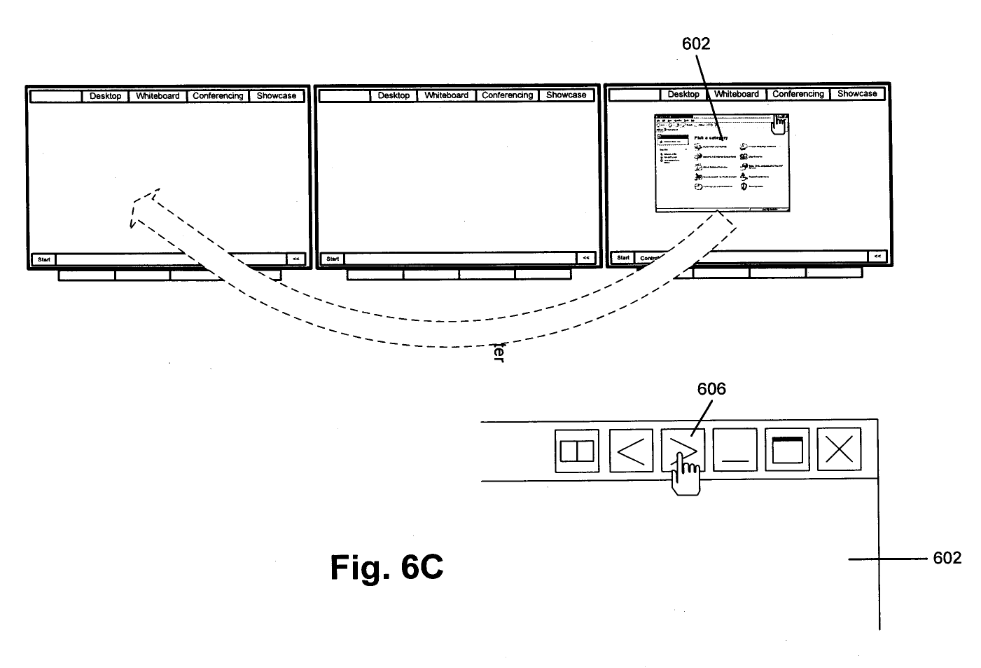

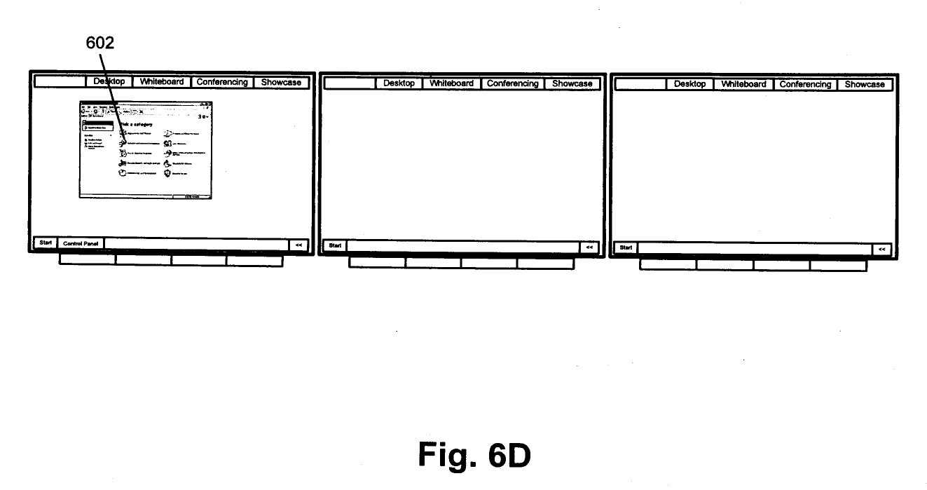

If desired, the application window for one or more of the application programs running on the central computer can be provided with one or more application window move (AWM) icons that allow the application window to be moved from one IWB to another. For example turning now to FIG. 6A, an application window 602 displayed on the touch surface of the leftmost IWB is shown. As can be seen, the top right-hand corner of the application window 602 comprises a left move icon “<” 604 and a right move icon “>” 606. When a user selects the right move icon “>” 606, the central computer 28 in response to the touch input moves the application window 602 from the current IWB to the IWB to its right (i.e. in this example to the middle IWB) as shown in FIG. 6B. Selecting the right move icon “>” 606 of the application window 602 that is now displayed on the middle IWB, results in the application window moving from the middle IWB to the rightmost IWB as shown in FIG. 6C. Selecting the right move icon “>” 606 of the application window 602 that is now displayed on the rightmost IWB, results in the application window wrapping around from the rightmost IWB back to the leftmost IWB as shown in FIG. 6D. Similar steps are performed when the left move icon “<” 604 is selected except that the application window 602 is moved in the opposite direction.

Alternatively, following the first application window move from an IWB as a result of selection of one of the AWM icons 604 or 606, the AWM icons alone or the application window including the AWM icons could persist on the IWB from which the selection was made for a threshold period determined by a timer allowing a user to select an AWM icon more than once thereby to initiate application window moves across multiple IWBs without having to move to another IWB. For example, following selection of an AWM icon, as the AWM icons persist, the user can select the same AWM icon without moving to another IWB resulting in the application window moving across two IWBs. In this case, each time the user interacts with a persistent AWM icon, the timer resets thereby to give the user further opportunity to interact with the persistent AWM icons.

Similar to the previous embodiment, movement of the application window from one IWB to another IWB can be animated across the IWBs and/or sound effects can be broadcast to accompany movement of the application window from one IWB to another IWB.

If desired, application move icons associated with particular IWBs can be provided in conjunction with or instead of directional application move icons. In this case, when an application move icon associated with a particular IWB is selected, the application window is moved to the IWB associated with the selected application move icon.

The application management procedure may comprise program modules including but not limited to routines, programs, object components, data structures etc. and may be embodied as computer readable program code stored on a computer readable medium. The computer readable medium is any data storage device that can store data, which can thereafter be read by a computer system. Examples of computer readable medium include for example read-only memory, random-access memory, CD-ROMs, magnetic tape and optical data storage devices. The computer readable program code can also be distributed over a network including coupled computer systems so that the computer readable program code is stored and executed in a distributed fashion.

Although embodiments have been described above with reference to the figures, those of skill in the art will appreciate that variations and modifications may be made without departing from the spirit and scope thereof as defined by the appended claims.

1. A system comprising a plurality of displays operatively associated with at least one computing device executing an application management procedure, said application management procedure determining instances of applications available on the displays and enabling an application selected from one display that is available on another display to be moved from that other display.

2. A system according to claim 1 wherein said application management procedure causes a representation of each application available on the displays to be presented on a selected display.

3. A system according to claim 2 wherein said application management procedure is invoked in response to user input associated with a display.

4. A system according to claim 3 wherein said application management procedure is invoked in response to user selection of a displayed icon and wherein the selected display is the display from which the displayed icon is selected.

5. A system according to claim 4 wherein a plurality of said displays present said icon.

6. A system according to any one of claim 2 wherein the representation of each application is a selectable thumbnail.

7. A system according to any one of claim 2 wherein said plurality of displays comprises a plurality of interactive whiteboards.

8. A system according to claim 7 wherein each interactive whiteboard is selected from the group comprising analog resistive, capacitive, camera-based, electromagnetic and surface acoustic wave touch panels.

9. A system according to claim 8 wherein the application selected from the one display is moved from the other display to the one display.

10. A system according to claim 9 wherein the selected application is presented on the one display in a format similar to that previously presented on the other display.

11. A system according to claim 9 wherein the selected application is presented on the one display at a location similar to that previously presented on the other display.

12. A system according to claim 9 wherein said application management procedure animates the selected application during movement of the selected application from the other display to the one display.

13. A system according to claim 9 wherein said application management procedure causes said at least one computing device to broadcast a sound effect during movement of the selected application from the other display to the one display.

14. A method of managing applications in a multi-monitor computer system comprising a plurality of displays, said method comprising:
displaying representations of available applications in the multi-monitor computer system on at least one of the displays; and
in response to selection of a representation of an application that is available on a different display, transferring the application associated with the selected representation to the display from which the selection was made.

15. The method of claim 14 wherein said displaying comprises presenting an array of symbols representing said available applications.

16. The method of claim 15 wherein said symbols are thumbnail representations of said available applications.

17. The method of claim 14 wherein said displaying is performed in response to user input made on said one display.

18. The method of claim 17 wherein said user input is selection of an icon presented on said one display.

19. The method of claim 17 wherein said user input is touch input made on said one display.

20. The method of claim 14 wherein said transferring comprises displaying the application associated with the selected representation on the display from which the selection was made.

21. The method of claim 20 wherein the application is displayed in a format similar to that as presented on the different display.

22. The method of claim 20 wherein the application is displayed at a location similar to that as presented on the different display.

23. The method of claim 20 further comprising animating movement of the application associated with the selected representation from the different display to the display from which the selection was made.

24. The method of claim 20 further comprising broadcasting a sound effect during said transferring.

25. A multi-monitor computer system comprising a plurality of displays operatively associated with a central computing device executing an application management procedure, said application management procedure, in response to user input made on one of said displays, at least determining applications running on said central computing device that are available for presentation on the displays, and displaying selectable representations of the applications on the one display, said application management procedure in response to selection of a displayed representation associated with an application available on a display different from said one display, moving the availability of the application corresponding to the selected representation from the different display to the one display.

26. A multi-monitor computer system according to claim 25 wherein the selectable representations are thumbnails.

27. A multi-monitor computer system according to claim 25 wherein said application management procedure performs said determining and displaying in response to selection of an icon presented on the one display.

28. A multi-monitor computer system according to claim 27 wherein a plurality of said displays present said icon.

29. A multi-monitor computer system according to claim 28 wherein each display presents said icon.

30. A multi-monitor computer system according to claim 25 wherein said plurality of displays comprises a plurality of interactive whiteboards.

31. A multi-monitor computer system according to claim 30 wherein each interactive whiteboard is selected from the group comprising analog resistive, capacitive, camera-based, electromagnetic and surface acoustic wave touch panels.

32. A multi-monitor computer system according to claim 25 further comprising at least one remote computing device communicating with said central computing device.

33. A multi-monitor computer system according to claim 32 wherein said application management procedure also determines applications running on said at least one remote computing device and displays representations of those applications on the one display.

34. A multi-monitor computer system according to claim 32 wherein said at least one remote computing device and said central computing device communicate over one of a wired and wireless communication link.

35. A multi-monitor computer system according to claim 25 wherein the application moved from the different display to the one display is presented on the one display in a format similar to that as previously presented on the different display.

36. A multi-monitor computer system according to claim 34 wherein the application moved from the different display to the one display is presented on the one display at a location similar to that as previously presented on the different display.

37. A computer readable medium embodying a computer program for managing applications in a multi-monitor computer system comprising a plurality of displays, said computer program comprising:
program code for displaying representations of available applications in the multi-monitor computer system on at least one of the displays; and
program code for, in response to selection of a representation of an application available on a different display, transferring the application associated with the selected representation to the display from which the selection was made.

38. A method of managing applications in a multi-monitor computer system comprising a plurality of displays, said method comprising:
displaying at least one application move icon associated with an application window presented on one of said displays; and
in response to selection of the at least one application move icon, transferring display of the application window from the one display to another display.

39. The method of claim 38 wherein said transferring comprises displaying the application window on a display adjacent the one display.

40. The method of claim 39 wherein during said displaying at least two application move icons are displayed, each application move icon being associated with movement of the application window from the one display to a different adjacent display.

41. The method of claim 39 wherein each application move icon forms part of the application window.

42. The method of claim 38 wherein said at least one application move icon is multiplably selectable.

43. A computer readable medium embodying a computer program for managing applications in a multi-monitor computer system comprising a plurality of displays, said computer program comprising:
program code for displaying at least one application move icon associated with an application window presented on one of said displays; and
program code for, in response to selection of the at least one application move icon, transferring display of the application window from the one display to another display.
